(19) United States
(12) Patent Application Publication
(10) Pub. No.: US 2010/0108256 A1
(43) Pub. Date: May 6, 2010

(54) CLOSED LOOP CONTROL OF ADHESIVE DOT CHARACTERISTICS

(75) Inventors: REANGROAJ ROAJANASIRI, THANYABURI (TH); WARANYA THIRAPUTTIPONG, BANGKOK (TH)

Correspondence Address: WESTERN DIGITAL TECHNOLOGIES, INC.;ATTN: LESLEY NING, 20511 LAKE FOREST DR., E-118G, LAKE FOREST, CA, 92630, US

(73) Assignee: WESTERN DIGITAL TECHNOLOGIES, INC., Lake Forest, CA (US)

(21) Appl. No.: 12/265,313

(22) Filed: Nov. 5, 2008

(51) Int. Cl. B32B 7/14; G06F 17/30

(52) U.S. Cl. 156/291; 156/578

(57) ABSTRACT

A plurality of adhesive dots are dispensed, and a characteristic for each of the plurality of adhesive dots is measured. An average and statistical dispersion for the measured characteristics of the plurality of adhesive dots are determined. The average in then compared to a function of a reference characteristic value and the statistical dispersion. A change to be made to a physical parameter of a subsequent adhesive dot is determined based at least in part on the comparison, and the subsequent adhesive dot is dispensed onto a subsequent disk drive suspension based at least in part on the change.

### BACKGROUND

Automatic adhesive dispensing systems are used in a variety of industries to efficiently join parts in a manufacturing assembly line. Typically, an adhesive dispenser is used to apply adhesive onto a part moving relative to the adhesive dispenser (e.g., on a conveyor). The adhesive may be dispensed under pressure applied by a piston or a motor driven pump to form an adhesive dot on the part.

In such manufacturing environments, it is often necessary to accurately dispense the adhesive to form an adhesive dot having a desired size and shape at a precise location. However, the accuracy of the adhesive dispensing process may be adversely impacted by a variety of variables, including: general environmental conditions, the physical state of the adhesive being dispensed, the physical condition of the adhesive dispenser, the stability of electrical and other system parameters, etc. Changes in these variables can cause the adhesive dot formed by the adhesive dispensing system to vary from desired target values.

In the magnetic disk drive manufacturing environment, automated adhesive dispensing systems are often used to attach sliders to disk drive suspensions. As schematically illustrated in FIG. 1, in a typical process, an adhesive dot 1 00 may be dispensed onto a disk drive suspension 102, and a slider 104 may be picked up and then attached to the disk drive suspension 102. If a size of the adhesive dot 100 is not within a serviceable range of values, however, the slider 104 may not adequately adhere to the disk drive suspension 102, or adhesive material may be exposed beyond the slider 104. Such failures in the adhesive dispensing process may significantly impact disk drive suspension yield and thus increase the ultimate manufacturing cost for magnetic disk drives.

There is therefore a need in the art for an improved adhesive dispensing process.

### BRIEF DESCRIPTION OF THE DRAWINGS

FIG. 1 is a schematic view illustrating a slider above a disk drive suspension carrying an adhesive dot.

FIG. 2 is a schematic view illustrating an example adhesive dispensing system, according to one illustrated embodiment.

FIG. 3 is a schematic view illustrating the example adhesive dispensing system of FIG. 2 in greater detail, according to one illustrated embodiment.

FIG. 4 is a flow chart illustrating one method of operating a feedback system for an adhesive dispenser, according to one illustrated embodiment.

FIG. 5 is a flow chart illustrating one method of manufacturing disk drives, according to one illustrated embodiment.

FIGS. 6A and 6B show a flow chart illustrating one method of operating a feedback system for an adhesive dispenser in greater detail, according to one illustrated embodiment.

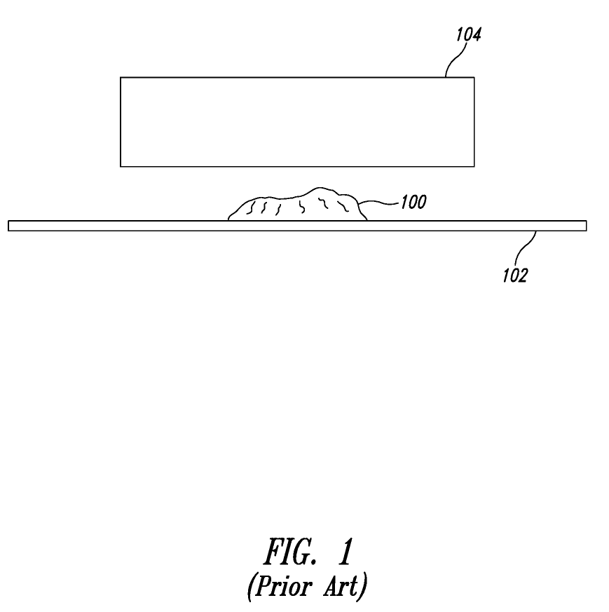

### DETAILED DESCRIPTION

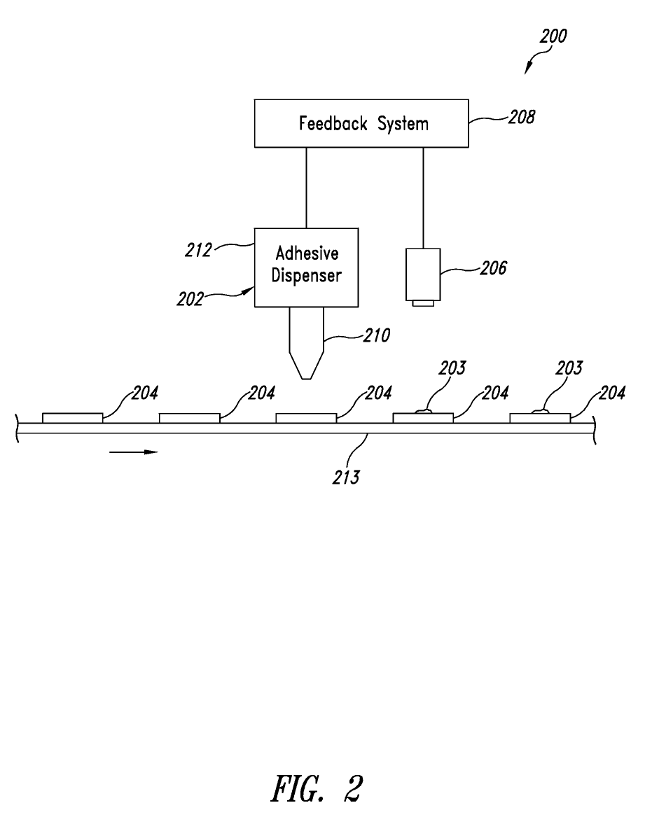

Referring to FIG. 2, in one embodiment, an adhesive dispensing system 200 includes an adhesive dispenser 202 configured to dispense adhesive dots 203 onto disk drive suspensions 204, an adhesive monitoring device 206 positioned downstream from the adhesive dispenser 202 and configured to measure a characteristic for each of the adhesive dots 203, and a feedback system 208. In one embodiment, as described in greater detail below, the feedback system 208 is operable to: receive information from the adhesive monitoring device 206 indicative of the measured characteristics of the adhesive dots 203; determine an average for the measured characteristics of the adhesive dots 203; determine a statistical dispersion for the measured characteristics of the adhesive dots 203; compare the average to a function of a reference characteristic value and the statistical dispersion; and modify a control variable associated with the adhesive dispenser 202 based at least in part on the comparison.

In the illustrated embodiment, the adhesive dispensing system 200 dispenses adhesive dots 203 onto disk drive suspensions 204. However, in other embodiments, similarly configured adhesive dispensing systems may dispense adhesive in a variety of different manufacturing environments. For example, an adhesive dispensing system may dispense adhesive in a microelectronic manufacturing environment, or in a manufacturing environment for plastics. The adhesive dispensing systems and processes described herein may thus be implemented in any of these manufacturing environments.

The adhesive dispensed by the adhesive dispensing system 200 may comprise any of a variety of adhesives depending upon the manufacturing environment. In one embodiment, the adhesive may comprise UV123HGA glue produced by the Norland Company. This adhesive may be quickly cured by exposure to ultraviolet light.

The adhesive dispenser 202 may have a variety of different configurations. In one embodiment, the adhesive dispenser 202 includes an adhesive dispensing nozzle 210. The adhesive dispensing nozzle 210 may be communicatively coupled to a source of adhesive within a body 212 of the adhesive dispenser 202. In one embodiment, the source of adhesive may comprise an adhesive tank within the body 212, and a source of compressed air may be coupled to the adhesive tank in order to pneumatically force adhesive out via the adhesive dispensing nozzle 210. In other embodiments, other mechanisms for dispensing adhesive may be used. For example, a mechanically driven piston may be positioned within the adhesive tank in order to drive the adhesive out through the nozzle 210.

As illustrated, the adhesive dispenser 202 may be positioned above a conveyor belt 213, which moves the disk drive suspensions 204 from left to right in FIG. 2. In one embodiment, the conveyor belt 213 may be automatically controlled to stop periodically such that each disk drive suspension 204 is briefly positioned underneath the adhesive dispenser 202 at an appropriate location to receive an adhesive dot 203. In such an embodiment, the adhesive dispenser 202 may be configured to stay absolutely motionless. In other embodiments, the adhesive dispenser 202 may be configured to move, and the disk drive suspensions 204 may remain motionless as the adhesive dispenser 202 moves from one to the other, dispensing the adhesive dots 203. In still other embodiments, the conveyor belt 213 may move the disk drive suspensions 204 to an approximate location under the adhesive dispenser 202, and the adhesive dispenser 202 may then be moved to achieve a finer control over the placement of the adhesive dots 203. For example, the adhesive dispenser 202 may incorporate a machine vision system to accurately place the adhesive dots 203.

The adhesive monitoring device 206 may be configured to measure any of a variety of characteristics of the adhesive dots 203. In one embodiment, the adhesive monitoring device 206 may be configured to measure a size for each of the adhesive dots 203. For example, the adhesive monitoring device 206 may be configured to measure at least one of a diameter, a height or a weight of the adhesive dots 203. In another embodiment, the adhesive monitoring device 206 may be configured to measure a dispensed location for each of the adhesive dots 203. Such a location measurement may be taken relative to an absolute coordinate system, or may be taken relative to some other component or feature.

The adhesive monitoring device 206 may also comprise any of a variety of devices for taking such measurements or otherwise determining the characteristics. In one embodiment, the adhesive monitoring device 206 may comprise a machine vision system. The machine vision system may be configured, for example, to measure a diameter for each of the adhesive dots 203. The machine vision system may also or alternatively be configured to measure the location of each of the adhesive dots 203. In other embodiments, the adhesive monitoring device 206 may comprise one or more scales for measuring an approximate weight of the adhesive dots 203. For example, for each of the disk drive suspensions 204, before and after weight measurements may be taken along the conveyor belt 213 in order to determine an approximate weight of the adhesive dots 203.

The adhesive monitoring device 206 may be positioned at a variety of locations downstream from the adhesive dispenser 202. As used herein, it may be understood that the term “downstream” is used as a general term to indicate that the adhesive monitoring device 206 is positioned so as to measure characteristics for the adhesive dots 203 after the adhesive dispenser 202 has dispensed the adhesive dots 203. In one embodiment, as illustrated, the adhesive monitoring device 206 may be positioned downstream from the adhesive dispenser 202 along the conveyor belt 213. In another embodiment, the adhesive dispenser 202 may be moved relative to the disk drive suspensions 204, and the adhesive monitoring device 206 may be configured to move relative to the disk drive suspensions 204 as well, taking measurements of the adhesive dots 203 after the adhesive dispenser 202 has deposited them. In still another embodiment, the adhesive monitoring device 206 may be substantially co-located with the adhesive dispenser 202, and the disk drive suspension 204 may remain motionless as the adhesive dispenser 202 first dispenses an adhesive dot 203, and the adhesive monitoring device 206 then measures a characteristic of the adhesive dot 203.

The feedback system 208 may comprise any of a variety of systems communicatively coupled to and configured to receive information from the adhesive monitoring device 206. The feedback system 208 may be further configured to analyze such information, and modify a control variable associated with the adhesive dispenser 202. In one embodiment, the feedback system 208 may comprise a computing device including at least one interface communicatively coupled to the adhesive monitoring device 206, and at least one interface communicatively coupled to the adhesive dispenser 202. In another embodiment, the feedback system 208 may comprise a hard-wired electronic device, such as an application specific integrated circuit (“ASIC”).

The feedback system 208 may be located proximate the adhesive dispenser 202 and the adhesive monitoring device 206, as illustrated, or the feedback system 208 may be remotely located. In one embodiment, the feedback system 208 may be located remotely and shared among a variety of different adhesive dispensers 202 and adhesive monitoring devices 206. In another embodiment, the feedback system 208 may be incorporated into the body of the adhesive dispenser 202 or the adhesive monitoring device 206

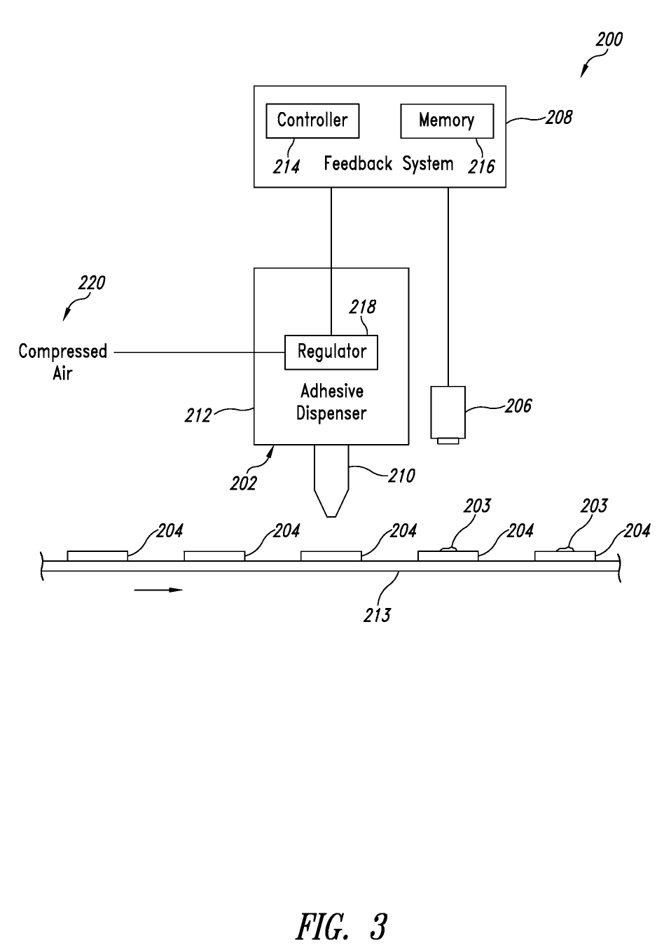

In FIG. 3, the feedback system 208 and the adhesive dispenser 202 are illustrated in greater detail. In one embodiment, the feedback system 208 may comprise a computing device including a controller 214 and a memory 216. The controller 214 may be operable to execute instructions, and the memory 216 may have computer-readable instructions stored thereon that are executable by the controller 214 in order to cause the controller 214 to process information indicative of characteristics of a plurality of adhesive dots 203 dispensed by the adhesive dispenser 202. The controller 214 may comprise any of a variety of processing units operable to execute instructions, and the memory 216 may comprise any computer-readable memory, such as a hard disk drive, optical disk drive, solid state memory device, etc.

In one embodiment, the memory 216 may have instructions stored thereon that enable the feedback system 208 to perform the acts described above. In another embodiment, the memory 216 may have instructions stored thereon to cause the controller 214 to: determine an average for the characteristics of the plurality of adhesive dots 203; determine a statistical dispersion for the characteristics of the plurality of adhesive dots 203; compare the average to a function of a reference characteristic value and the statistical dispersion; and modify a control variable associated with the adhesive dispenser 202 based at least in part on the comparison. In different embodiments, the memory 216 may include other instructions for controlling the feedback system 208 and other components of the adhesive dispensing system 200.

As illustrated in FIG. 3, the adhesive dispenser 202 may include a pressure regulator 218 coupled to a source of compressed air 220. The adhesive dispensing nozzle 210 may in turn be coupled to an adhesive tank (not shown) communicatively coupled to the source of compressed air 220 via the pressure regulator 218. Thus, the pressure applied to the adhesive within the adhesive tank may be controlled using the pressure regulator 218.

In one embodiment, the pressure regulator 218 may comprise an electronic pressure regulator communicatively coupled to the feedback system 208. By changing the settings of the pressure regulator 218, the feedback system 208 may modify a control variable associated with the adhesive dispenser 202 and thereby control the size of the adhesive dots 203. For example, the feedback system 208 may signal the pressure regulator 218 to allow greater pressure to be applied to the adhesive in the adhesive tank, resulting in larger adhesive dots 203.

In different embodiments, the adhesive dispensing system 200 may incorporate a variety of other devices and feedback mechanisms. For example, in one embodiment, the adhesive dispensing system 200 may include an actuator for moving the adhesive dispenser 202 relative to the disk drive suspensions 204. In such an embodiment, the feedback system 208 may provide feedback for controlling this actuator in order to improve location accuracy for the dispensed adhesive dots 203.

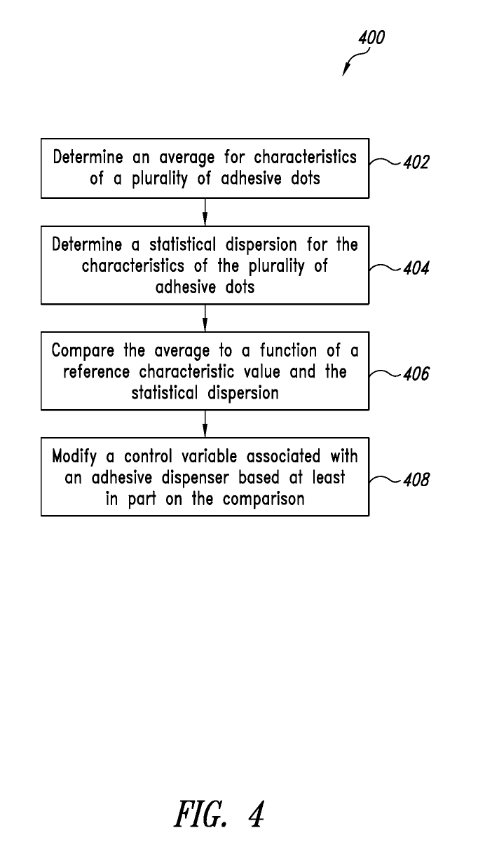

FIG. 4 illustrates a flow diagram for a method 400 of operating a feedback system for an adhesive dispenser, according to one embodiment. The method 400 will be discussed in the context of the adhesive dispensing system 200 illustrated in FIG. 3. However, the acts disclosed herein may be executed in a variety of different manufacturing environments with different adhesive dispensing systems, in accordance with the described method.

As described herein, all of the acts comprising the method 400 may be orchestrated by the controller 214 based at least in part on execution of computer-readable instructions stored in the memory 216. In other embodiments, a hardware implementation of all or some of the acts of method 400 may be used.

At act 402, an average for characteristics of a plurality of adhesive dots 203 is determined. As described above, these characteristics may comprise size characteristics (e.g., a diameter, height, weight, and/or circumference), location characteristics (e.g., absolute or relative positioning information), or other physical characteristics of the plurality of adhesive dots 203.

In one embodiment, the adhesive dispensing system 200 may include an adhesive monitoring device 206 configured to measure or otherwise determine the characteristics for each of the plurality of adhesive dots 203. The adhesive monitoring device 206 may then send information indicative of the measured characteristics of the adhesive dots 203 to the feedback system 208 for analysis. In one embodiment, the information indicative of the measured characteristics may be sent one data point at a time from the adhesive monitoring device 206 to the feedback system 208. For example, upon the completion of each measurement, information indicative of that measurement may be sent to the feedback system 208. In other embodiments, the adhesive monitoring device 206 may buffer the information before sending it on to the feedback system 208.

The plurality of adhesive dots 203 for which the average is determined at act 402 may comprise any quantity of adhesive dots 203. In one embodiment, the plurality of adhesive dots 203 may comprise approximately 50 adhesive dots 203. Such a sample size may provide a statistically significant snapshot of the adhesive dots 203, while allowing relatively rapid intervention if the adhesive dispensing system 200 begins to malfunction. In other embodiments, more or fewer adhesive dots may be used in act 402 based upon the particular needs of the adhesive dispensing system. For example, a sample size including fewer adhesive dots 203 may be used in order to increase the reaction time of the feedback system 208. Meanwhile, a sample size including more adhesive dots 203 may be used in order to prevent unnecessary corrections to the adhesive dispenser 202.

The feedback system 208 may determine any of a variety of averages for the measured characteristics. In one embodiment, the average comprises a mean of the characteristics of the plurality of adhesive dots 203. In other embodiments, the average may comprise a median, a geometric median, a truncated mean, a weighted mean, a mode, etc.

At act 404, a statistical dispersion for the characteristics of the plurality of adhesive dots 203 is determined. The feedback system 208 may determine any of a variety of measures of statistical dispersion. In one embodiment, the statistical dispersion may comprise a standard deviation of the characteristics of the plurality of adhesive dots 203. In other embodiments, the statistical dispersion may comprise a range, an interquartile range, a mean difference, a median absolute deviation, an average absolute deviation, a coefficient of variation, a quartile coefficient of dispersion, a relative mean difference, a variance, a variance to mean ratio, etc. In different embodiments, particular measures of the statistical dispersion may be preferable.

At act 406, the average is compared to a function of a reference characteristic value and the statistical dispersion. As used in act 406, the term “function” refers to a mathematical function, which in act 406 takes both the reference characteristic value and the statistical dispersion as variables.

In one embodiment, the reference characteristic value comprises a target value for the characteristics of the adhesive dots 203. For example, if the characteristic comprises a diameter of the adhesive dots 203, then the reference characteristic value may comprise a target diameter. That is, the reference characteristic value may comprise a nominal value for the diameter. In other embodiments, the reference characteristic value may comprise one of a plurality of acceptable values for the diameter.

Thus, the average of the characteristics of the plurality of adhesive dots 203 may be compared against a mathematical function of the reference characteristic value and the statistical dispersion. In one embodiment, this comparison may be indicative of the extent to which the average of the measured characteristics varies from the reference characteristic value as a function of the statistical dispersion of the measured characteristics. For example, if the statistical dispersion comprises a standard deviation, the comparison may indicate that the average is more than one standard deviation away from a target value for the measured characteristic. As another example, the comparison may indicate that the average is more than two standard deviations away from the target value for the measured characteristic.

In some embodiments, such a comparison may yield better information for determining whether or not the adhesive dispensing process should be adjusted than a simple comparison between the average and the reference characteristic value, since the comparison of act 406 also yields information regarding the variability (i.e., the statistical dispersion) of the data. That is, in some instances, the average of the characteristics may vary significantly from the reference characteristic value, but the measured characteristics may have such a large statistical dispersion that it is not efficient to adjust the adhesive dispensing process based on this set of characteristics. On the other hand, the average of the characteristics may only vary slightly from the reference characteristic value, but the measured characteristics may have such a tight statistical dispersion that it is efficient to adjust the adhesive dispensing process to bring the average even closer to the reference characteristic value.

At act 408, a control variable associated with the adhesive dispenser 202 is modified based at least in part on the comparison. In one embodiment, the feedback system 208 may send electrical signals to a component of the adhesive dispenser 202 in order to modify the control variable associated with the adhesive dispenser 202. In another embodiment, the feedback system 208 may send electrical signals to some other component of the adhesive dispensing system 200 in order to modify the control variable associated with the adhesive dispenser 202. In still other embodiments, other mechanisms for modifying the control variable may be used.

The control variable may comprise any of a variety of control variables associated with the adhesive dispenser 202. For example, in one embodiment, the control variable may represent a pressure setting of the pressure regulator 218. In another embodiment, the control variable may correspond to a time interval during which the adhesive dispenser 202 dispenses adhesive dots 203. In such an embodiment, the feedback system 208 may cause a controller (not shown) of the adhesive dispenser 202 to dispense adhesive for a longer or shorter time interval. In yet another embodiment, the control variable may correspond to a location metric for positioning the adhesive dispenser 202 relative to the disk drive suspensions 204. In such an embodiment, the feedback system 208 may cause the adhesive dispenser 202 itself to be positioned differently, or may instead cause the conveyor belt 213 to stop at different locations.

In one embodiment, as described in greater detail below, the control variable may be modified in order to cause the characteristics of the plurality of adhesive dots 203 to more closely approximate the reference characteristic value. For example, if the average of the characteristics of the plurality of adhesive dots 203 is below the function of the reference characteristic value and the statistical dispersion, then the control variable may be varied in order to cause the characteristic to increase. Of course, despite this modification to the control variable, the individual characteristics of subsequently dispensed adhesive dots may vary from the reference characteristic value by more or less than the average determined at act 402, based at least in part on the statistical variation of the adhesive dispensing process.

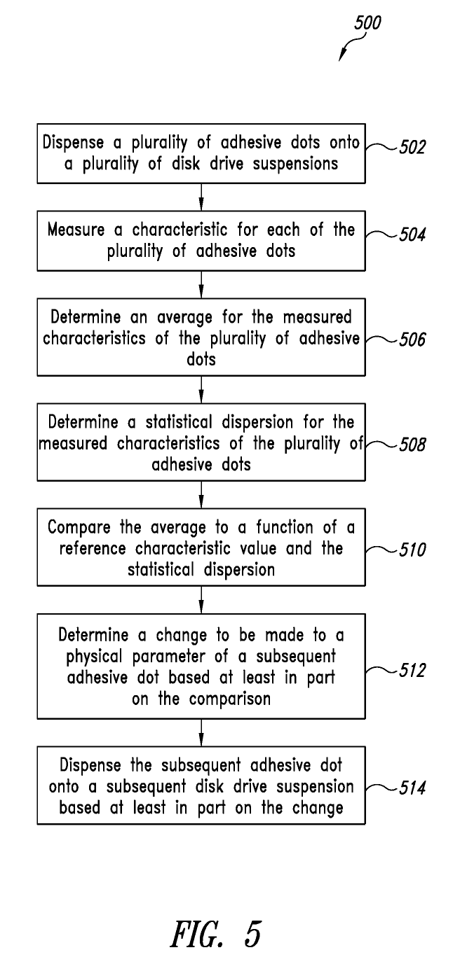

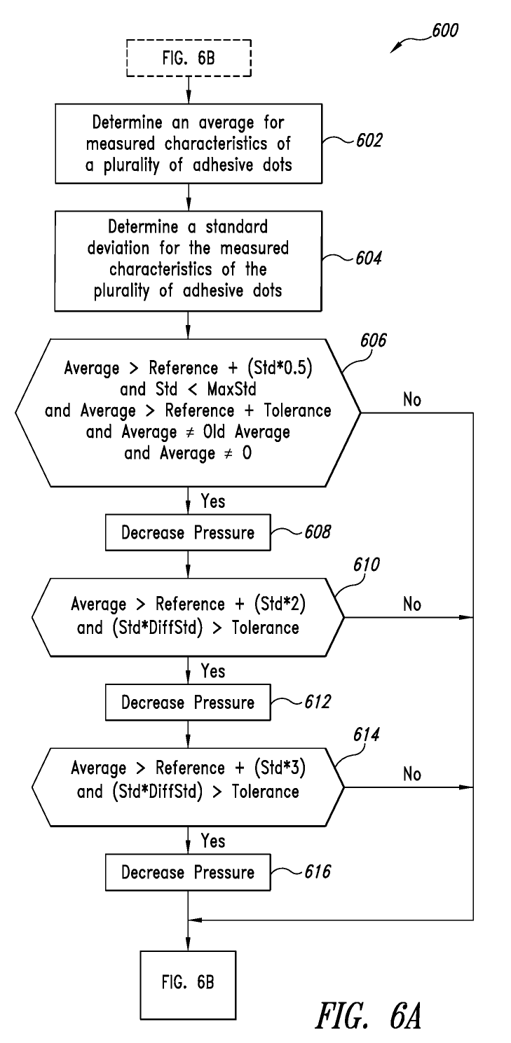

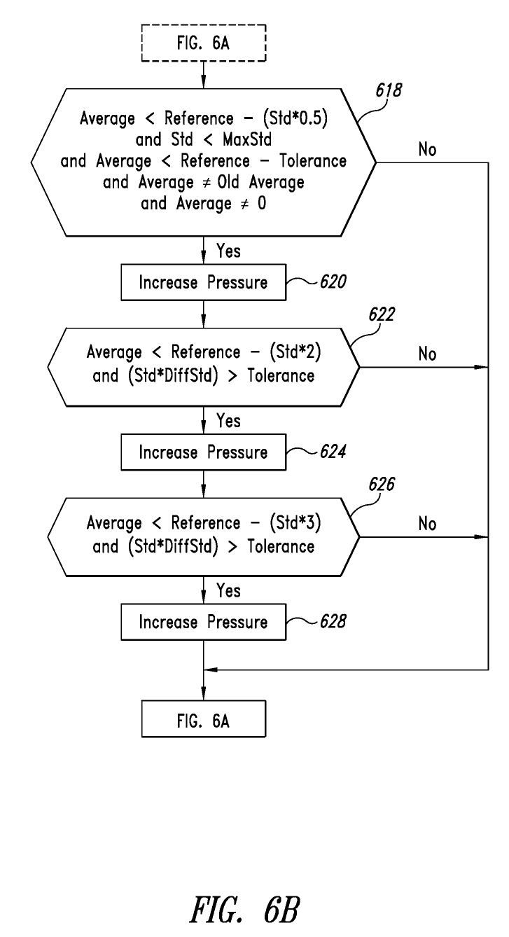

The control variable may also be modified by different amounts in different embodiments. In some embodiments, the control variable may be modified by a single increment or decrement. For example, the control variable may be modified by a tolerance value, which is indicative of a minimum increment by which the control variable may be modified. The tolerance value may, in such an embodiment, reflect a minimum resolution for the control variable. In other embodiments, the control variable may be modified by different values depending upon how far the average has varied from the reference characteristic value. For example, the control variable may be modified by a first value if the average varies by a single standard deviation from the reference characteristic value, and by a second, larger value if the average varies by two standard deviations from the reference characteristic value. One particular algorithm for modifying the control variable is described in greater detail with respect to FIGS. 6A and 6B.

Although act 408 refers to a single control variable, it may be understood that multiple control variables associated with the adhesive dispenser 202 may be modified based at least in part on the comparison. In some embodiments, multiple characteristics may be measured, and multiple control variables may be modified substantially simultaneously. In other embodiments, multiple control variables may be modified in order to achieve changes in a single characteristic of the adhesive dots 203. In addition, as described in greater detail below with respect to FIGS. 6A and 6B, the control variable may be modified based on a plurality of comparisons and other tests.

FIG. 5 illustrates a flow diagram for a method 500 of manufacturing disk drives, according to one embodiment. The method 500 will be discussed in the context of the adhesive dispensing system 200 illustrated in FIG. 3. However, the acts disclosed herein may be executed in a variety of different manufacturing environments with different adhesive dispensing equipment, in accordance with the described method.

As described herein, all of the acts comprising the method 500 may be orchestrated by the controller 214 based at least in part on execution of computer-readable instructions stored in the memory 216. In other embodiments, a hardware implementation of all or some of the acts of method 500 may be used.

At act 502, a plurality of adhesive dots 203 are dispensed onto a plurality of disk drive suspensions 204. As described above, this plurality of adhesive dots 203 may comprise any quantity of adhesive dots 204. In one embodiment, the plurality of adhesive dots 203 may comprise approximately 50 adhesive dots 203. Such a sample size may provide a statistically significant snapshot of the dispensed adhesive dots 203, while allowing relatively rapid intervention if the adhesive dispensing system 200 begins to malfunction.

The plurality of adhesive dots 203 may be dispensed onto the disk drive suspensions 204 in a variety of ways. In one embodiment, the conveyor belt 213 may be automatically controlled to stop periodically such that each disk drive suspension 204 is briefly positioned underneath the adhesive dispenser 202 at an appropriate location to receive an adhesive dot 203. In other embodiments, the adhesive dispenser 202 may be configured to move, and the disk drive suspensions 204 may remain motionless as the adhesive dispenser 202 moves from one to the other, dispensing the plurality of adhesive dots 203. In still other embodiments, the conveyor belt 213 may move the disk drive suspensions 204 to an approximate location under the adhesive dispenser 202, and the adhesive dispenser 202 may then be moved to achieve a finer control over the placement of the adhesive dots 203.

At act 504, a characteristic for each of the plurality of adhesive dots 203 is measured. As described above, these measured characteristic may comprise size characteristics (e.g., a diameter, height, weight, and/or circumference), location characteristics (e.g., absolute or relative positioning information), or other physical characteristics. In some embodiments, multiple characteristics may be measured.

In addition, a variety of devices may be used to measure these characteristics. In one embodiment, the adhesive monitoring device 206 may be configured to measure the characteristics for each of the plurality of adhesive dots 203. The adhesive monitoring device 206 may then send information indicative of the measured characteristics for each of the adhesive dots 203 back to the feedback system 208 for analysis.

At act 506, an average for the measured characteristics of the plurality of adhesive dots 203 is determined. This average may be determined in a manner similar to that described with reference to act 402 above.

At act 508, a statistical dispersion for the measured characteristics of the plurality of adhesive dots 203 is determined. This statistical dispersion may be determined in a manner similar to that described with reference to act 404 above.

At act 510, the average is compared to a function of a reference characteristic value and the statistical dispersion. This comparison may be performed in a manner similar to that described with reference to act 406 above.

At act 512, a change to be made to a physical parameter of a subsequent adhesive dot is determined based at least in part on the comparison. The physical parameter may comprise any of a variety of physical parameters related to the measured characteristics. For example, in one embodiment, a physical parameter of the subsequent adhesive dot may comprise a size of the adhesive dot, and the measured characteristic may comprise a diameter, weight, height or other size-related characteristic of the adhesive dots 203. In another embodiment, the physical parameter may comprise a location of the adhesive dot, and the measured characteristic may comprise a relative or absolute location of the previously dispensed adhesive dots 203. In still another embodiment, the physical parameter may comprise the measured characteristic itself.

In one embodiment, the change to be made to the physical parameter may be determined such that the characteristic of the subsequent adhesive dot more closely approximates the reference characteristic value. For example, if the average of the measured characteristics of the plurality of adhesive dots 203 is below the function of the reference characteristic value and the statistical dispersion, then it may be determined that a size of a subsequent adhesive dot should be increased.

In one embodiment, the change may simply be indicative of an increase or decrease of the physical parameter, without assigning any value to the change. In other embodiments, it may be determined that the physical parameter should be changed by a quantifiable amount. For example, it may be determined that the width of the subsequent adhesive dot should be decreased by 5 μm. This quantifiable change may be variable or fixed in different embodiments.

At act 514, the subsequent adhesive dot is dispensed onto a subsequent disk drive suspension 204 based at least in part on the change. In one embodiment, the feedback system 208 may communicate with any of a number of components of the adhesive dispensing system 200 in order to modify a control variable associated with the adhesive dispenser 202 based at least in part on the change.

In one embodiment, the subsequent adhesive dot may be dispensed using control variables that make it more likely that the characteristic of the subsequent adhesive dot will more closely approximate the reference characteristic value. For example, if the average of the characteristics of the plurality of adhesive dots 203 is below the function of the reference characteristic value, then the subsequent adhesive dot may be dispensed using control variables that have been varied to cause the characteristic to increase. Of course, as described above, it may be understood that the individual characteristics of the subsequent adhesive dot may vary from the reference characteristic value by more or less than the average determined at act 506, based at least in part on the statistical variation of the adhesive dispensing process.

FIGS. 6A and 6B illustrate a flow chart for a method 600 of operating a feedback system for an adhesive dispenser in greater detail, according to one embodiment. The method 600 will be discussed in the context of the adhesive dispensing system 200 illustrated in FIG. 3. However, the acts disclosed herein may be executed in a variety of different manufacturing environments with different adhesive dispensing equipment, in accordance with the described method.

As described herein, all of the acts comprising the method 600 may be orchestrated by the controller 214 based at least in part on execution of computer-readable instructions stored in the memory 216. In other embodiments, a hardware implementation of all or some of the acts of method 600 may be used.

At act 602, an average for measured characteristics of a plurality of adhesive dots 203 is determined. The characteristics may be measured and the average determined in a manner similar to that described above with reference to acts 504 and 402 above.

At act 604, a standard deviation for the measured characteristics of the plurality of adhesive dots is determined. The standard deviation may be determined in a manner similar to that described above with reference to act 404 above.

At act 606, a number of comparisons are made in order to determine whether or not a pressure applied to form subsequent adhesive dots should be decreased at act 608. In different embodiments, more or fewer comparisons/tests may be used in order to determine whether or not to adjust a control variable, such as the pressure. For example, in some embodiments, the pressure applied at the pressure regulator 218 may be decreased at act 608 based solely on whether or not the first one or two of the comparisons listed in act 606 have been satisfied.

In one embodiment, the average is compared to a first sum of the reference characteristic value added to the standard deviation (i.e., the “Std”) multiplied by a first factor. As illustrated in act 606, the first factor may comprise 0.5, although different factors may be used in other implementations. If it is determined that the average is larger than the first sum, then it may be further determined that a size of a subsequent adhesive dot should be reduced by a first decrement based at least in part on this determination. In one embodiment, the first decrement may correspond to a minimum increment by which the size of the adhesive dots can be changed. In one embodiment, for example, a minimum unit by which the pressure of the pressure regulator 218 may be adjusted may correspond to an approximate change of 5 μm in a diameter of a subsequent adhesive dot. Thus, in one embodiment, it may be determined that the size of the subsequent adhesive dot should be reduced by 5 μm based at least in part on the determination that the average is larger than the first sum.

In one embodiment, the standard deviation is also compared to a maximum standard deviation (“MaxStd”). The maximum standard deviation may comprise a standard deviation value selected in order to ensure that the set of measured characteristics is not too variable. That is, it may be used to determine whether or not the determined average is reliable enough for basing decisions on whether or not to modify the adhesive dispensing process. In one embodiment, the maximum standard deviation may comprise 30 μm, where a normal standard deviation for the adhesive dispenser 202 may be between 8 and 20 μm. If it is determined that the standard deviation is not larger than the maximum standard deviation, then it may be further determined that the size of the subsequent adhesive dot should be reduced by the first decrement based at least in part on this additional determination.

In one embodiment, the average may be further compared to the reference characteristic value added to a tolerance value. As described above, the tolerance value may correspond to a minimum increment by which the size of the adhesive dots 203 can be changed. Thus, in one embodiment, this comparison may be used to prevent overshoot by ensuring that the average is greater than the reference characteristic value by at least a minimum increment by which the size of a subsequent adhesive dot may be changed. If it is determined that the average is larger than the reference characteristic value added to the tolerance value, then it may be further determined that the size of the subsequent adhesive dot should be reduced by the first decrement based at least in part on this additional determination.

In some embodiments, the current average is compared to an old average. The old average may correspond to a previous average of measured characteristics associated with a previous plurality of adhesive dots 203. In some embodiments, if the current average is equal to the old average, this may indicate that the adhesive dispensing process is proceeding abnormally. For example, it may indicate that the adhesive monitoring device 206 is taking inaccurate measurements.

In some embodiments, the average may be further compared to zero. If the average equals zero, it may indicate that the adhesive dispenser 202 has failed to deposit the adhesive dots, or that the adhesive monitoring device 206 has failed to properly detect the adhesive dots. In either case, the adhesive dispensing system 200 may be stopped, and diagnostics may be executed to determine why the average equals zero.

At act 608, if all of the comparisons of act 606 have been satisfied, a pressure applied during the adhesive dispensing process may be decreased. In one embodiment, the feedback system 208 may send an electrical signal to adjust a pressure setting of the pressure regulator 218. Thus, in one embodiment, an average size of subsequently dispensed adhesive dots may be reduced. Of course, in other embodiments, different control variables for a variety of components within the adhesive dispensing system 200 may be varied in order to decrease the size of subsequently dispensed adhesive dots.

In one embodiment, the pressure may be decreased by a minimum increment corresponding to a minimum resolution of a control variable associated with the pressure. However, in some embodiments, the average may have diverged widely from the reference characteristic value, and it may be desirable to further decrease the pressure. In such an embodiment, acts 610 through 616 provide a mechanism for accelerating the change in the size of subsequently dispensed adhesive dots when the average varies further from the reference characteristic value.

At act 610, a number of comparisons are again made in order to determine whether or not the pressure applied to form subsequent adhesive dots should be further decreased at act 612. In different embodiments, more or fewer comparisons/tests may be used in order to determine whether or not to further adjust the pressure. For example, in some embodiments, the pressure applied at the pressure regulator 218 may be decreased at act 612 based solely on whether or not the first comparison listed in act 610 has been satisfied.

In one embodiment, the average is compared to a second sum of the reference characteristic value added to the standard deviation multiplied by a second factor, the second factor being greater than the first factor described above with reference to act 606. As illustrated in act 610, the second factor may comprise two, although different factors may be used in other implementations. If it is determined that the average is larger than the second sum, then it may be further determined that the size of the subsequent adhesive dot should be reduced by a second decrement larger than the first decrement based at least in part on this determination. In one embodiment, the second decrement may simply correspond to two times the first decrement, which may correspond to a minimum increment by which the size of the adhesive dots can be changed. In other embodiments, the second decrement may correspond to some other multiple of the first decrement.

In one embodiment, the standard deviation is also multiplied by a differential standard deviation (“DiffStd”), and this result is compared with the tolerance value. In one embodiment, the differential standard deviation may comprise a statistical measure of the detectability of the standard deviation. Thus, this comparison may comprise another verification of the trustworthiness of the measured characteristics. In one embodiment, the differential standard deviation may equal 0.5, although different values may be used in other implementations. If it is determined that the standard deviation multiplied by the differential standard deviation is larger than the tolerance value, then it may be further determined that the size of the subsequent adhesive dot should be reduced by the second decrement based at least in part on this determination.

At act 612, if both of the comparisons of act 610 have been satisfied, a pressure applied during the adhesive dispensing process may be further decreased. In one embodiment, the feedback system 208 may send an electrical signal to further adjust a pressure setting of the pressure regulator 218. Thus, in one embodiment, an average size of subsequently dispensed adhesive dots may be further reduced. Of course, in other embodiments, different control variables for a variety of components within the adhesive dispensing system 200 may be varied in order to decrease the size of subsequently dispensed adhesive dots.

At act 614, a number of comparisons are again made in order to determine whether or not the pressure applied to form subsequent adhesive dots should be still further decreased at act 616. In different embodiments, more or fewer comparisons/tests may be used in order to determine whether or not to further adjust the pressure. For example, in some embodiments, the pressure applied at the pressure regulator 218 may be decreased at act 616 based solely on whether or not the first comparison listed in act 614 has been satisfied.

In one embodiment, the average is compared to a third sum of the reference characteristic value added to the standard deviation multiplied by a third factor, the third factor being greater than the second factor described above with reference to act 610. As illustrated in act 614, the third factor may comprise three, although different factors may be used in other implementations. If it is determined that the average is larger than the third sum, then it may be further determined that the size of the subsequent adhesive dot should be reduced by a third decrement larger than the second decrement based at least in part on this determination. In one embodiment, the third decrement may simply correspond to three times the first decrement, which may correspond to a minimum increment by which the size of the adhesive dots can be changed. In other embodiments, the third decrement may correspond to some other multiple of the first decrement.

In one embodiment, a result of the standard deviation multiplied by the differential standard deviation is again compared with the tolerance value, in a manner similar to that described above with respect to act 610. If it is determined that the standard deviation multiplied by the differential standard deviation is larger than the tolerance value, then it may be further determined that the size of the subsequent adhesive dot should be reduced by the third decrement based at least in part on this determination.

At act 616, if both of the comparisons of act 614 have been satisfied, a pressure applied during the adhesive dispensing process may be further decreased. In one embodiment, the feedback system 208 may send an electrical signal to further adjust a pressure setting of the pressure regulator 218. Thus, in one embodiment, an average size of subsequently dispensed adhesive dots may be further reduced. Of course, in other embodiments, different control variables for a variety of components within the adhesive dispensing system 200 may be varied in order to decrease the size of subsequently dispensed adhesive dots.

Acts 618 through 628 are similar to acts 606 through 616 described at length above, except that the comparisons are changed where appropriate to ensure that the average is lower than respective mathematical functions of the reference characteristic value. For example, at act 618, the average is compared to a first result of the standard deviation multiplied by a first factor subtracted from the reference characteristic value. If it is determined that the average is smaller than the first result, then it may be determined that a size of a subsequent adhesive dot should be increased by a first increment based at least in part on this determination. At act 618, the average may also be compared to a result of the tolerance value subtracted from the reference characteristic value. If it is determined that the average is larger than the tolerance value subtracted from the reference characteristic value, then it may be further determined that the size of the subsequent adhesive dot should be increased by the first increment based at least in part on this additional determination.

Similarly, at act 622, the average is compared to a second result of the standard deviation multiplied by a second factor subtracted from the reference characteristic value, the second factor being greater than the first factor. If it is determined that the average is smaller than the second result, then it may be determined that a size of a subsequent adhesive dot should be further increased by a second increment larger than the first increment based at least in part on this determination. At act 626, the average is compared to a third result of the standard deviation multiplied by a third factor subtracted from the reference characteristic value, the third factor being greater than the second factor. If it is determined that the average is smaller than the third result, then it may be determined that a size of a subsequent adhesive dot should be further increased by a third increment larger than the second increment based at least in part on this determination.

As illustrated in FIG. 6B, upon completing the acts 602 through 628, the method 600 may return to the beginning, and another average may be calculated for another plurality of adhesive dots. Thus, in one embodiment, the adhesive dispensing system 200 may be constantly monitored and may constantly respond to feedback based on a previously dispensed plurality of adhesive dots.

The foregoing detailed description has set forth various embodiments of the devices and/or processes via the use of block diagrams, schematics, and examples. Insofar as such block diagrams, schematics, and examples contain one or more functions and/or operations, each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, the embodiments disclosed herein, in whole or in part, can be equivalently implemented in integrated circuits, as one or more programs executed by one or more processors, as one or more programs executed by one or more controllers (e.g., microcontrollers), as firmware, or as virtually any combination thereof.

We/I claim:

1. A method of manufacturing disk drives, the method comprising:
dispensing a plurality of adhesive dots onto a plurality of disk drive suspensions;
measuring a characteristic for each of the plurality of adhesive dots;
determining an average for the measured characteristics of the plurality of adhesive dots;
determining a statistical dispersion for the measured characteristics of the plurality of adhesive dots;
comparing the average to a function of a reference characteristic value and the statistical dispersion;
determining a change to be made to a physical parameter of a subsequent adhesive dot based at least in part on the comparison; and
dispensing the subsequent adhesive dot onto a subsequent disk drive suspension based at least in part on the change.

2. The method of claim 1, wherein measuring the characteristic includes measuring a size for each of the plurality of adhesive dots.

3. The method of claim 2, wherein measuring the size for each of the plurality of adhesive dots comprises measuring a diameter for each of the plurality of adhesive dots using a machine vision system.

4. The method of claim 1, wherein determining the average includes determining a mean of the characteristics of the plurality of adhesive dots.

5. The method of claim 1, wherein determining the statistical dispersion includes determining a standard deviation of the characteristics of the plurality of adhesive dots.

6. The method of claim 5, wherein comparing the average to a function of the reference characteristic value and the statistical dispersion includes:
comparing the average to a first sum of the reference characteristic value added to the standard deviation multiplied by a first factor; and
determining that the average is larger than the first sum; and
wherein determining the change to be made to the physical parameter of the subsequent adhesive dot includes determining that a size of the subsequent adhesive dot should be reduced by a first decrement based at least in part on the determination that the average is larger than the first sum.

7. The method of claim 6, further comprising:
comparing the standard deviation to a maximum standard deviation; and
determining that the standard deviation is not larger than the maximum standard deviation;
wherein determining the change to be made to the physical parameter of the subsequent adhesive dot further includes determining that the size of the subsequent adhesive dot should be reduced by the first decrement based at least in part on the determination that the standard deviation is not larger than the maximum standard deviation.

8. The method of claim 6, further comprising:
comparing the average to the reference characteristic value added to a tolerance value; and
determining that the average is larger than the reference characteristic value added to the tolerance value;
wherein determining the change to be made to the physical parameter of the subsequent adhesive dot further includes determining that the size of the subsequent adhesive dot should be reduced by the first decrement based at least in part on the determination that the average is larger than the reference characteristic value added to the tolerance value.

9. The method of claim 8, wherein the tolerance value corresponds to a minimum increment by which the size can be changed.

10. The method of claim 6, further comprising:
comparing the average to a second sum of the reference characteristic value added to the standard deviation multiplied by a second factor, the second factor greater than the first factor; and
determining that the average is larger than the second sum;
wherein determining the change to be made to the physical parameter of the subsequent adhesive dot further includes determining that the size of the subsequent adhesive dot should be reduced by a second decrement larger than the first decrement based at least in part on the determination that the average is larger than the second sum.

11. The method of claim 10, further comprising:
comparing the average to a third sum of the reference characteristic value added to the standard deviation multiplied by a third factor, the third factor greater than the second factor;
determining that the average is larger than the third sum;
wherein determining the change to be made to the physical parameter of the subsequent adhesive dot further includes determining that the size of the subsequent adhesive dot should be reduced by a third decrement larger than the second decrement based at least in part on the determination that the average is larger than the third sum.

12. The method of claim 5, wherein comparing the average to a function of the reference characteristic value and the statistical dispersion includes:
comparing the average to a first result of the standard deviation multiplied by a first factor subtracted from the reference characteristic value; and
determining that the average is smaller than the first result; and
wherein determining the change to be made to the physical parameter of the subsequent adhesive dot includes determining that a size of the subsequent adhesive dot should be increased by a first increment based at least in part on the determination that the average is smaller than the first result.

13. The method of claim 12, further comprising:
comparing the average to a second result of the standard deviation multiplied by a second factor subtracted from the reference characteristic value, the second factor greater than the first factor;
determining that the average is smaller than the second result;
wherein determining the change to be made to the physical parameter of the subsequent adhesive dot further includes determining that the size of the subsequent adhesive dot should be increased by a second increment larger than the first increment based at least in part on the determination that the average is smaller than the second result.

14. The method of claim 13, further comprising:
comparing the average to a third result of the standard deviation multiplied by a third factor subtracted from the reference characteristic value, the third factor greater than the second factor;
determining that the average is larger than the third result;
wherein determining the change to be made to the physical parameter of the subsequent adhesive dot further includes determining that the size of the subsequent adhesive dot should be increased by a third increment larger than the second increment based at least in part on the determination that the average is smaller than the third result.

15. The method of claim 1, wherein dispensing the subsequent adhesive dot onto the subsequent disk drive suspension based at least in part on the change includes modifying a pressure applied to an adhesive dispenser.

16. The method of claim 1, wherein dispensing the subsequent adhesive dot onto the subsequent disk drive suspension based at least in part on the change includes modifying a time interval during which adhesive is dispensed to form the subsequent adhesive dot.

17. The method of claim 1, wherein dispensing the subsequent adhesive dot onto the subsequent disk drive suspension based at least in part on the change includes modifying a location metric used to identify a location to dispense the subsequent adhesive dot.

18. An adhesive dispensing system, comprising:
an adhesive dispenser configured to dispense adhesive dots onto disk drive suspensions;
an adhesive monitoring device positioned downstream from the adhesive dispenser and configured to measure a characteristic for each of the adhesive dots; and
a feedback system communicatively coupled to the adhesive monitoring device and operable to:
receive information from the adhesive monitoring device indicative of the measured characteristics of the adhesive dots;
determine an average for the measured characteristics of the adhesive dots;
determine a statistical dispersion for the measured characteristics of the adhesive dots;
compare the average to a function of a reference characteristic value and the statistical dispersion; and
modify a control variable associated with the adhesive dispenser based at least in part on the comparison.

19. The adhesive dispensing system of claim 18, wherein the adhesive monitoring device is further configured to measure a size for each of the adhesive dots.

20. The adhesive dispensing system of claim 19, wherein the adhesive monitoring device comprises a machine vision system configured to measure a diameter for each of the adhesive dots.

21. The adhesive dispensing system of claim 18, wherein the feedback system is further operable to determine a mean of the characteristics of the adhesive dots.

22. The adhesive dispensing system of claim 18, wherein the feedback system is further operable to determine a standard deviation of the characteristics of the adhesive dots.

23. The adhesive dispensing system of claim 22, wherein the function of the reference characteristic value and the statistical dispersion is a first sum of the reference characteristic value added to the standard deviation multiplied by a first factor, and wherein the feedback system is further operable to:
determine that the average is larger than the first sum; and
modify the control variable by a first decrement in order to reduce a size of a subsequent adhesive dot based at least in part on the average being larger than the first sum.

24. The adhesive dispensing system of claim 23, wherein the feedback system is further operable to:
compare the average to a second sum of the reference characteristic value added to the standard deviation multiplied by a second factor, the second factor greater than the first factor;
determine that the average is larger than the second sum; and
modify the control variable by a second decrement larger than the first decrement in order to reduce the size of the subsequent adhesive dot based at least in part on the average being larger than the second sum.

25. The adhesive dispensing system of claim 22, wherein the function of the reference characteristic value and the statistical dispersion is a first result of the standard deviation multiplied by a first factor subtracted from the reference characteristic value, and wherein the feedback system is further operable to:
determine that the average is smaller than the first result; and
modify the control variable by a first increment in order to increase a size of a subsequent adhesive dot based at least in part on the average being smaller than the first result.

26. The adhesive dispensing system of claim 25, wherein the feedback system is further operable to:
compare the average to a second result of the standard deviation multiplied by a second factor subtracted from the reference characteristic value, the second factor greater than the first factor;
determine that the average is smaller than the second result; and
modify the control variable by a second increment larger than the first increment in order to increase the size of the subsequent adhesive dot based at least in part on the average being smaller than the second result.

27. The adhesive dispensing system of claim 18, wherein the control variable corresponds to a pressure applied at the adhesive dispenser to dispense adhesive dots.

28. The adhesive dispensing system of claim 18, wherein the control variable corresponds to a time interval during which the adhesive dispenser dispenses adhesive dots.

29. The adhesive dispensing system of claim 18, wherein the control variable corresponds to a location metric for positioning the adhesive dispenser relative to disk drive suspensions.

30. A feedback system for an adhesive dispenser, the feedback system comprising:
a controller operable to execute instructions; and
a memory having computer-readable instructions stored thereon that are executable by the controller in order to cause the controller to process information indicative of characteristics of a plurality of adhesive dots dispensed by the adhesive dispenser, by:
determining an average for the characteristics of the plurality of adhesive dots;
determining a statistical dispersion for the characteristics of the plurality of adhesive dots;
comparing the average to a function of a reference characteristic value and the statistical dispersion; and
modifying a control variable associated with the adhesive dispenser based at least in part on the comparison.

31. The feedback system of claim 30, wherein the characteristics comprise sizes for each of the plurality of adhesive dots.

32. The feedback system of claim 31, wherein the characteristics comprise diameters for each of the plurality of adhesive dots.

33. The feedback system of claim 30, wherein determining the average includes determining a mean of the characteristics of the plurality of adhesive dots.

34. The feedback system of claim 30, wherein determining the statistical dispersion includes determining a standard deviation of the characteristics of the plurality of adhesive dots.

35. The feedback system of claim 34, wherein the function of the reference characteristic value and the statistical dispersion is a first sum of the reference characteristic value added to the standard deviation multiplied by a first factor, and wherein the memory has further computer-readable instructions stored thereon that are executable by the controller in order to cause the controller to process information, by:
determining that the average is larger than the first sum; and
modifying the control variable by a first decrement in order to reduce a size of a subsequent adhesive dot based at least in part on the average being larger than the first sum.

36. The feedback system of claim 35, wherein the memory has further computer-readable instructions stored thereon that are executable by the controller in order to cause the controller to process information, by:
comparing the average to a second sum of the reference characteristic value added to the standard deviation multiplied by a second factor, the second factor greater than the first factor;
determining that the average is larger than the second sum; and
modifying the control variable by a second decrement larger than the first decrement in order to reduce the size of the subsequent adhesive dot based at least in part on the average being larger than the second sum.

37. The feedback system of claim 34, wherein the function of the reference characteristic value and the statistical dispersion is a first result of the standard deviation multiplied by a first factor subtracted from the reference characteristic value, and wherein the memory has further computer-readable instructions stored thereon that are executable by the controller in order to cause the controller to process information, by:
determining that the average is smaller than the first result; and
modifying the control variable by a first increment in order to increase a size of a subsequent adhesive dot based at least in part on the average being smaller than the first result.

38. The feedback system of claim 37, wherein the memory has further computer-readable instructions stored thereon that are executable by the controller in order to cause the controller to process information, by:
comparing the average to a second result of the standard deviation multiplied by a second factor subtracted from the reference characteristic value, the second factor greater than the first factor;
determining that the average is smaller than the second result; and
modifying the control variable by a second increment larger than the first increment in order to increase the size of the subsequent adhesive dot based at least in part on the average being smaller than the second result.

39. The feedback system of claim 30, wherein the control variable corresponds to a pressure applied at the adhesive dispenser to dispense adhesive dots.

40. The feedback system of claim 30, wherein the control variable corresponds to a time interval during which the adhesive dispenser dispenses adhesive dots.

41. The feedback system of claim 30, wherein the control variable corresponds to a location metric used to position the adhesive dispenser relative to disk drive suspensions.
